(19) United States
(12) Patent Application Publication
(10) Pub. No.: US 2026/0348529 A1
(43) Pub. Date: Nov. 5, 2026

(54) LIGHTWEIGHT CRYOGENIC VESSEL, AND METHOD FOR MANUFACTURING SAME

(71) Applicant: NAWAH, Rousset (FR)

(72) Inventors: Brian Rice, Mason, OH (US); Paul KLADITIS, Clayton, OH (US); Kevin RETZ, West Chester, OH (US); Lingchuan LI, Dayton, OH (US); Pascal BOULANGER, Eguilles (FR)

(73) Assignee: NAWAH, Rousset (FR)

(21) Appl. No.: 19/488,123

(22) PCT Filed: May 27, 2024
(86) PCT No.: PCT/IB2024/055141

§ 371 Date: Nov. 26, 2025

Related U.S. Application Data
(60) Provisional application No. 63/469,066, filed on May 26, 2023.

(51) Int. Cl. F17C 13/00; B32B 1/00; B32B 5/02; B32B 7/03

(52) U.S. Cl. CPC F17C 13/001; B32B 1/00; B32B 5/02; B32B 7/03; B32B 2262/101; B32B 2262/106; B32B 2307/7375; B32B 2439/40; F17C 2203/0602

(57) ABSTRACT

Cryogenic vessel for storage of compressed or liquefied gases such as hydrogen, oxygen, nitrogen or air, comprising a composite part built up from alternating superposed composite layers of a laminate composite comprising fibers embedded in a polymer matrix, wherein an array of vertically aligned nanotubes or nanofibers is arranged between two superposed laminate layers.

### TECHNICAL FIELD

The present invention relates to the field of vessels for containing or storing compressed or liquefied gases at cryogenic temperatures, said vessels being made from composite materials comprising fiber-reinforced polymer matrix composites, or comprising such composite materials as an outer reinforcement layer. Said composite materials are formed by superposed plies, each ply comprising fibers embedded in resin.

The present invention uses composite materials in which arrays of vertically arranged carbon nanotubes are used as reinforcing elements between adjacent plies.

### BACKGROUND

While the term “cryogenic temperatures” does not seem to have a universally accepted meaning, it is normally not applied to temperatures above a threshold value of about 120 K, knowing that the boiling points of so-called permanent gases (such as He, H₂, Ne, N₂, O₂, F₂, Ar, CO, CH₄ and air) lies below this value. This is how this term is used in the framework of the present invention.

Cryogenic temperatures, and the way to cool down a material or a workpiece from room temperature to cryogenic temperature and to heat it up again, and repeating these cycles potentially several times, may raise issues related to the reliability of materials and assemblies. To mention not more than a few causes: while certain static dynamic mechanical properties (such as tensile strength) tend to improve at low temperature, certain dynamic mechanical properties (such as impact strength) may decrease. Structural transformations may occur at cryogenic temperature (this is for instance the case in most martensic steels, carbon steels and cast iron), and indeed, certain bulk materials are prone to cold embrittlement. Moreover, certain composite materials and certain assemblies made of dissimilar materials are prone to thermally induced cracking due to a mismatch in coefficients of thermal expansion between two materials that are in contact. Indeed, constant thermal cycling of the tanks is anticipated to be harmful to the tank's structural integrity. And at last, but not at least, fatigue resistance under repeated or fluctuating local stress is always an issue with materials used for pressure vessels.

As a consequence, many materials are unsuitable for cryogenic use. Suitable materials include certain metallic materials (such as certain aluminium alloys, austenitic stainless steel, copper, brass, certain nickel steel), quartz, certain fiber-reinforced plastics. Initially, most cryogenic vessels for industrial use had been made from appropriate metallic materials. For stationary cryogenic vessels, the weight of a metallic construction is usually not a problem. Concerning composite materials, carbon/epoxy based cryogenic storage tanks are prone to microcracking which may lead to reduced structural integrity and concerns regarding leakage or permeability. Use of liners to prevent leakage is compromised by the severe mismatch of thermal expansion coefficient of candidate liner materials, both metallic and polymeric. There is a need to develop advanced composite materials which can overcome these problems.

Cryo-compressed storage of gases is used in many industries, and its use in vehicles (such as cars, trucks, ships, aircraft and space vehicles) is increasing as natural gas or hydrogen are promoted as an alternative to liquid hydrocarbons. Also, liquefied gases at cryogenic temperatures are increasingly used as a coolant for superconducting magnets. The development of lightweight vessels for cryo-compressed storage of oxygen and hydrogen was fostered by the space shuttle program. First, external tanks manufactured from welded aluminium alloy sheets were covered with a multi-layered thermal protective coating, the coating being applied as a spray-on poly(isocyanurate) foam insulation that is approximately one inch thick. As thrust imposed on the storage tank during launch and ascent of the space vehicle may damage this foam coating, metal-lined storage tanks with skin layers made from composite materials have been developed.

Cryogenic hydrogen storage leads to specific problems due to the high diffusion coefficient of hydrogen in many materials, and due to chemical reactions leading to structural fragilization of certain metallic alloys, in particular of certain types of steel. This problem can be addressed by using inner liners, thereby separating the tightness function from the structural function of the pressure vessel. Additionally, overwraps can be used as a further structural reinforcement. Advanced light-weight design of vessels for cryo-compressed storage of hydrogen needs also to address the issue of thermal insulation.

US 2005/0001100 (Hsi-Wu and Torres) discloses different designs of skin layers that can be used with storage tanks for cryo-compressed storage. These skin layers exhibit high compression strength and high tensile strength. They can be grid or mesh patterns comprising inter-connected fibers formed from an aramid fiber material (such as Kevlar™ and Twaron™). These grid or mesh patterns are added to the poly(isocyanurate) foam, thereby forming a composite material. The addition of carbon nanotubes to said foam increases both its compression strength and fire or heat protection.

Filament winding around liners made from metal or plastics (possibly composite materials) is used for reinforcement; this process can be automatized, but this is not an easy task.

For tanks for cryo-compressed storage of gases for uses other than in space vehicles, these designs would comply with the requirements of lightweight vessels. However, it would be desirable to have lightweight materials which perform better than existing composite materials at cryogenic temperatures, either when used as a liner or as an outer reinforcement layer.

In particular, microcracking is known both to alter the static and dynamic mechanical properties of a structural composite material, but also to increase its permeability for hydrogen (see: D. Schultheiss, “Permeation Barrier for Lightweight Liquid Hydrogen Tanks,” Ph.D. Thesis University of Augsburg, 16 Apr. 2007; see E. H. Stokes, “Hydrogen Permeability of a Polymer Based Composite Tank Material Under Tetra-Axial Strain”, 5^{th} Conf. on Aerospace Materials, Processes and Environmental Technology (AMPET), Sep. 16-18, 2002, Huntsville, Alabama; see J. Condé-Wolter et al., “Hydrogen permeability of thermoplastic composites and liner systems for future mobile applications”, Composites: Part A 167 (2023), 107446)). Due to microcracking, results obtained for the effects of cryogenic environments on stiffness, strength and toughness of fiber reinforced plastics are however rather contradictory (see J. Hohe et al., “Performance of fiber reinforced materials under cryogenic conditions—A review”, Composites: Part A 141 (2021), 106226), since thermally induced residual stresses may develop at different levels within the composite material, which are highly anisotropic systems. It is however well known that the formation of micro crack networks in fiber-reinforced composite materials leads to an increase in gas permeability. The present invention aims at providing improved lightweight cryogenic vessels for hydrogen storage using composite materials, which show in particular an improved resistance to microcracking.

### SUMMARY OF THE INVENTION

The inventors have recognized that certain composite materials in which vertically aligned carbon nanotube (VACNT) forests are placed between plies of polymer matrix composites (PMC) show significant benefit for their mechanical properties and certain other material properties, in particular at cryogenic temperatures.

More precisely, the present inventors have found that VACNT interleaved between the plies of a laminate composite (commercially available as NawaStitch™) suppress and arrest microcracking during mechanical loading under cryogenic conditions, as it occurs in cryogenic pressure vessels upon cyclic charging and discharging of pressurized gas or liquid at cryogenic temperature. It is known from prior art that such cracks can eventually join to become larger cracks and result in leaking or exploding tanks.

The inventors have used this approach to make a cryogenic vessel for storage of compressed or liquefied gases such as hydrogen, oxygen, nitrogen or air, comprising a composite part built up from alternating superposed composite layers of a laminate composite comprising fibers embedded in a polymer matrix (said superposed composite layers being called here “laminate layers”), wherein an array of vertically aligned nanotubes or nanofibers is arranged between two superposed laminate layers.

According to specific embodiments of the invention:
said composite layers comprises parallel fibers embedded in a polymer matrix;
said fibers are selected from carbon fibers and glass fibers;
said vertically aligned nanotubes or nanofibers are carbon nanotubes or nanofibers, deposited onto said composite layers;
in two superposed layers of laminate composite, and preferably in each two superposed layers of laminate composite, said fibers do not have the same orientation with respect to the plane of said layers;
the number of said alternating horizontal layers is at least 3, and preferably at least 5;
said array of vertically aligned nanotubes or nanofibers is partially embedded in the polymer matrix of each of the two adjacent superposed layers;
said an array of vertically aligned nanotubes or nanofibers has an average tube length comprised between about 10 μm and about 150 μm, preferably between about 10 μm and about 100 μm, and still more preferably between about 10 μm and about 50 μm.

Said cryogenic vessel can have different shapes and structures. Said gaseous or liquid hydrogen, oxygen, nitrogen or air can be in direct contact with said composite part, or there can be an inner liner, which can be a metallic or non-metallic part. Said composite part can for instance be one or more of a tronc, a connector, a tubing, or a dome. Alternatively, said vessel is formed from one single composite part.

According to the invention, the cryogenic vessel can be made by a method wherein said composite part is formed by successive superposition of composite layers, each said composite layers comprising fibers embedded in a polymer matrix, wherein an array of vertically aligned nanotubes or nanofibers is arranged between two superposed laminate layers.

The outer surface or an outer layer of the vessel can comprise a composite layer comprising a horizontal alignment of nanotubes or nanofibers with respect to said layers.

According to a variant of the invention, a VACNT layer can be mechanically rolled into a horizontal alignment of carbon nanotubes (HACNTs) covering the outer surface of a composite structure to act as a non-permeable liner that matches the coefficient of thermal expansion (CTE) of the composite which is critical for composite, liquid/gas storage tanks that operate under widely varying temperature conditions, such as cryogenic conditions, whereas otherwise a liner that does not have a matching CTE will eventually detach from the tank surface and resulting in a leaking or exploding tank. The HACNT can be fixed to the composite surface using the host composite matrix or a different matrix.

### BRIEF DESCRIPTION OF THE DRAWINGS

FIG. 1 schematically shows the manufacturing process of a ply of a composite material that can be used for making the invention, as used for making the NawaStitch™ material, which is part of the state of the art.

FIG. 2 shows a scanning electron microscopic image of a cross section of a ply used making NawaStitch™ panels. “CNT” indicates the VACNT layer on the surface of the ply. The round discs (“F”) are cross sectional views of carbon fibers present in the prepreg ply, the letter “R” indicates the resin.

FIG. 3 schematically shows the fabrication and layup of the samples used for embodiments of the invention. Baseline panels and NawaStitch™ panels were cut from the same prepreg sheets (also called “plies”), the only difference being the transfer of VACNT arrays on the tooling side of the prepreg plies used for forming NawaStitch™ panels.

FIG. 4 shows the cutting plan for obtaining specimens for In-Plane Shear testing according to ASTM D3518 from baseline panels and NawaStitch™ panels.

FIG. 5 shows the cutting plan for obtaining specimens for Open-Hole Tension testing according to ASTM D5766 from baseline panels and NawaStitch™ panels.

FIG. 6 shows a typical curve obtained from an open-hole tension test, for NawaStitch™ sample (a,A) and for a baseline sample (b,B). The test was stopped at a certain value of displacement without rupture. Onset of initial audible cracking is marked for each sample by the arrow.

FIG. 7 shows a curve obtained from cyclic testing of open-hole specimen at cryo temperature (−320 °F/−195.56 °C) for a NawaStitch™ sample (curve (a)) and a baseline sample (curve (b)).

FIG. 8 shows a scanning electron microscopy image of a cross section of a baseline panel after cyclic testing a cryo temperature as shown on FIG. 7. The length of the white bar is 100 μm. Circled areas are zoomed in FIGS. 9 and 10.

FIG. 9 shows a first zoom of a circled area of FIG. 8.

FIG. 10 shows a second and a third zoom of circled areas of FIG. 8.

FIG. 11 shows a scanning electron microscopy image of a cross section of a NawaStitch™ panel after cyclic testing a cryo temperature as shown on FIG. 7. The length of the white bar is 100 μm. The circled area is zoomed in FIG. 12.

FIG. 12 shows a zoom of the circled area of FIG. 11.

### DETAILED DESCRIPTION OF EMBODIMENTS

It is known that VACNT forest placed between plies of polymer matrix composites (PMCs) can improve the mechanical properties of the material. Such material is known from US 2009/0117363, EP 2 193 097 and U.S. Pat. No. 7,537,825 (all assigned to Massachusetts Institute of Technology) and WO 2015/120011 (assigned to N12 Technologies). The material described in these patents can be formed into rigid or semi-rigid panels which will be referred to as “NawaStitch™ panels” in the present specification.

NawaStitch™ panels are laminates formed by a plurality of parallel superposed plies; thereby forming a stack of plies. Each ply is formed by fibers (such as carbon fibers or glass fibers) embedded in a resin. Within each ply, said fibers are advantageously oriented parallel to each other. However, other orientations could be selected within the scope of the present invention, such as interwoven fibers. A plurality of plies are superposed (the stacking direction being denoted here as the z direction, whereas the plies extend in the x and y directions), preferably such that the orientation of fibres within two adjacent plies is different. Advantageously, if fibers are oriented parallel to each other within a ply, the adjacent ply is oriented such that the fiber orientation is orthogonal to that of the adjacent ply. Such stacks of plies are known as such. They can be laminated by applying pressure in the z-direction, and heat may also be applied during this process. Usually, the plies are supplied as preimpregnated sheets (so-called pre-pregs), wherein the resin is only partly cured, and under the effect of heat applied during the lamination process the curing of the resin will then be completed. In this way rigid panels composed of a plurality of parallel plies can be manufactured. It is known that the ultimate performance of such panels is limited by z-axis delamination.

Lamination can be carried out using a roller laminator of a known type. VACNT are grown on steel sheets and a prepreg is put on the top of said sheet, thereby forming a first complex. Said first complex is heated, and the rollers of the roller laminator are set at a certain temperature. Rolling is then carried out under a certain pre-set pressure onto the preheated prepreg. The resin of the pre-preg resin will penetrate under pressure into the preheated prepreg.

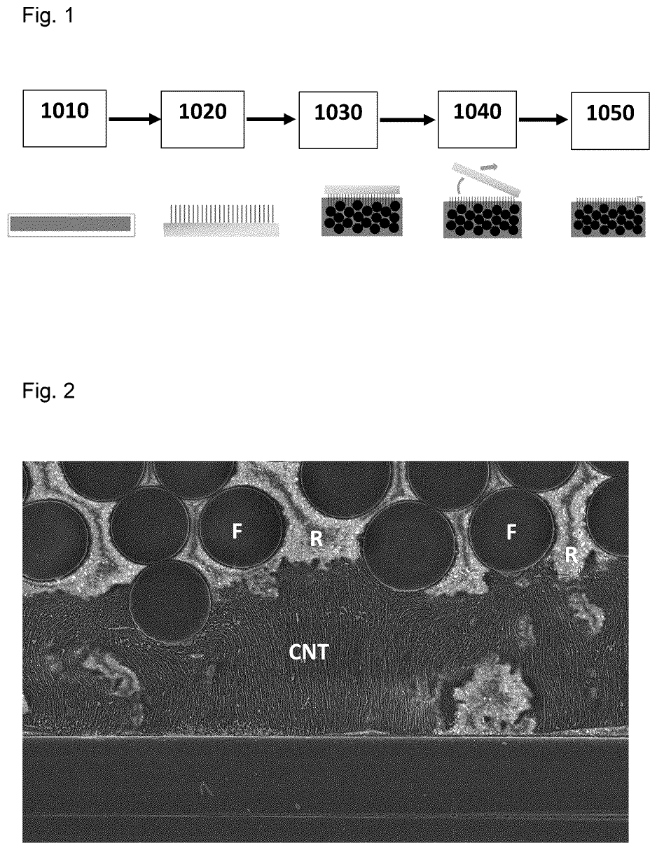

FIG. 1 schematically shows a process in which VACNT grown on a metallic substrate are transferred to another substrate, which can be a pre-preg ply. Reference numbers with four characters represent process steps or groups of process steps. In a first step 1010, a metallic substrate, such as steel or aluminium, is provided. In a first step or sequence of steps 1020, VACNT are deposited from a gas phase onto said substrate. Depending on the deposition method, the provided substrate is coated with a catalyst prior to gas phase deposition, or the catalyst precursor is continuously added to the gas phase during VACNT growth. In a second step or sequence of steps 1030, the VACNT on the coated metallic substrate are then pressed 1030 onto the pre-preg sheet such that the VACNT strongly adhere to the pre-preg sheet; this implies pressure exerted onto the substrate such that the VACNT penetrates the resin. This step can be carried out at room temperature or at an appropriate temperature above room temperature to allow softening of the thermoplastic resin. In a third step or sequence of steps 1040 the metallic substrate is then pulled off, leading to a composite sheet consisting of a pre-preg sheet coated with VACNT 1050. Transfer can be made simultaneously or independently on both side of the same pre-preg ply.

In the NawaStitch™ panels, an array formed by vertically aligned carbon nanotubes (VACNT) is arranged at the interface between two adjacent plies forming an x-y plane. Said array forms an interlayer between two adjacent plies. A photography of a cross section perpendicular to the x-y plane of such a ply obtained by scanning electron microscopy is shown on FIG. 2. The pre-preg sheet comprises carbon fibers impregnated with an appropriate resin. Letter “F” designates a carbon fiber. “VACNT” designates the VACNT interlayer. Letter “R” designates the resin in which the carbon fibers are embedded. As described in US 2009/0117363 A1, in a typical embodiment, each ply may have a thickness of the order of several hundreds of micrometres, the diameter of the individual fibers being of the order of about 5 μm to about 50 μm. The surface density and the thickness of said VACNT interlayer need to be adapted to the target value of electrical resistivity. Typical values for the thickness of the VACNT interlayer (i.e., the length of the nanofibers or nanotubes) are comprised between about 10 μm and about 150 μm, for example.

In the framework of the present invention, said VACNT interlayer advantageously has a thickness comprised between about 10 μm and about 50 μm, and more preferably between about 10 μm and about 25 μm.

Upon lamination (step 1030), said resin may penetrate at least in part into the free space between adjacent nanotubes forming the VACNT array. When the resin is then completely cured, said VACNT interlayer will be intimately bound to the resin component of the adjacent plies. This has been shown to improve adhesion between adjacent plies. In this sense, the composite panel devices according to the invention may also present mechanical properties which are interesting for the designer of mechanical parts.

In this way, composite panels comprising a stack formed by a plurality of pre-preg sheets and at least one layer of VANCT can be manufactured. The lamination of sandwiches comprising pre-preg sheets and a VACNT layer is known as such and will not be explained here in more detail. The fiber direction of the pre-preg sheets can be chosen such that the resulting composite panel exhibits specific properties. As an example, pre-preg composite comprising several pre-preg sheets can be built up such that each pre-preg sheet that is added to the composite has a fiber direction that is rotated by typical angles of 150 or 300 or 450 or 600 or even 900 with respect to the pre-preg sheet onto which it is laminated. Upon lamination, said resin may penetrate at least in part into the free space between adjacent nanotubes forming the VACNT array. When the resin is then completely cured, said VACNT interlayer will be intimately bound to the resin component of the adjacent plies. This has been shown to improve adhesion between adjacent plies.

The present inventors have now recognized that such a material has specific benefits in cryogenic applications, as it surprisingly exhibits properties that are significantly improved over conventional PMC materials.

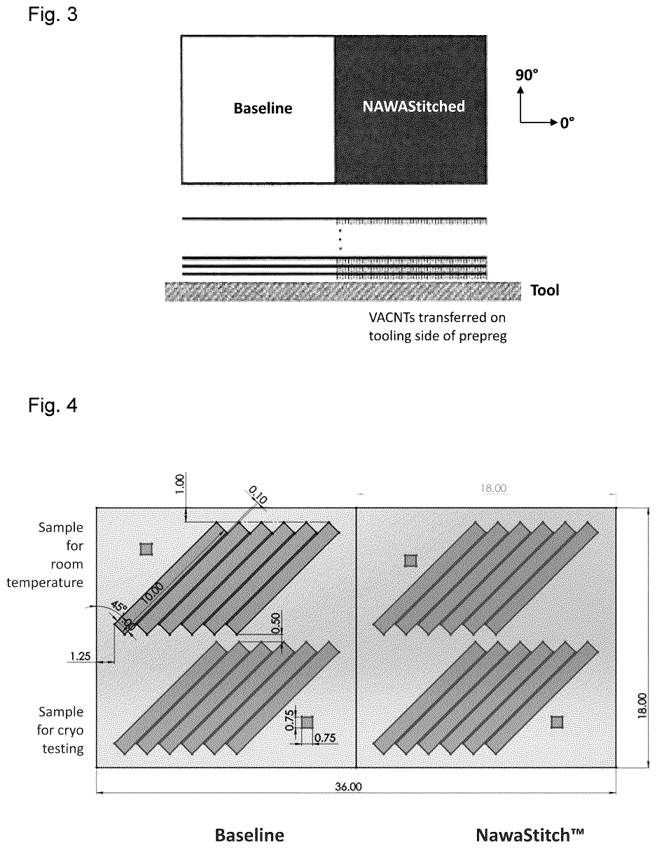

The present inventors have compared NawaStitch™ panels according to the invention to baseline panels according to prior art. As schematically shown on FIG. 3, NawaStitch™ panels and baseline panels were prepared in the same run, using the same plies, except that for the NawaStitch™ portion of the panel, VACNT arrays were transferred on the tooling side of the prepreg. A Teijin unitape prepreg with Q183 rapid-cure resin with HTS40 fiber (250 g/m²) was used for the baseline product and the NawaStitch™ panel. Panel size and geometry depended upon the purpose of said panel as a test piece.

Panels for ASTM D3518 In-Plane Shear specimens were of dimensions 18″×36″ and exhibited a stacking sequence of 16 plies at (0.90)_{4S}. Expected panel thickness was 0.16″, expected cured ply thickness was 0.01″. The cut plan of samples is shown on FIG. 4. The small squares are samples for acid digestion.

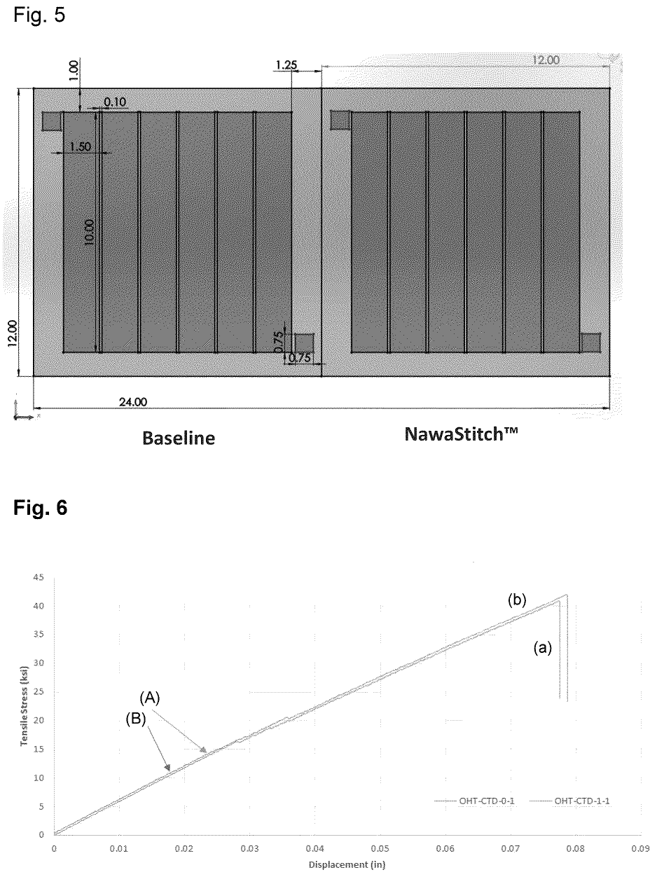

Panels for ASTM D5766 Open-Hole Tension specimens were of dimensions 12″×24″ and exhibited a stacking sequence of 16 plies at (45.90,−45.0)_{2S}. Expected panel thickness was 0.16″, expected cured ply thickness was 0.01″. The cut plan of samples is shown on FIG. 5. The small squares are samples for acid digestion.

Table 1 shows typical results for the physical characterization of the samples.

| | Cured | | | | | |
|---|---|---|---|---|---|---|
| | ply | Panel | Fiber | Matrix | Void | CNT |
| | thickness | thickness | volume | volume | volume | volume |
| Sample | [in] | [in] | [%] | (%] | [%] | [%] |
| Panel 1: IPS RT/Cryo Baseline | 0.0102 | 0.1636 | 52.99 | 46.74 | 0.27 | 0 |
| Panel 1: IPS RT/Cryo NawaStitch ™ | 0.0103 | 0.1645 | 52.29 | 47.57 | 0.15 | 0.81 |
| Panel 2: OHT RT Baseline | 0.0104 | 0.1657 | 53.05 | 46.76 | 0.19 | 0 |
| Panel 2: OHT RT NawaStitch ™ | 0.0104 | 0.1662 | 53.08 | 46.60 | 0.21 | 0.88 |
| Panel 3: OHT Cryo Baseline | 0.0103 | 0.1650 | 53.13 | 45.56 | 0.32 | 0 |
| Panel 3: OHT Cryo NawaStitch ™ | 0.0104 | 0.1657 | 53.02 | 47.00 | −0.03 | 0.42 |

The determination of the CNT volume assumes a CNT density of 1.41 g/cm³ and is segregated from the matrix digestion products. These volume values are estimates, as loss of CNT in filtration and unaccounted CNTs with the fiber reinforcement are not taken onto account.

Open Hole Tension testing was carried out in foam test chamber filled with liquid nitrogen. Typical results are shown on FIG. 6. The upper curve (b) represents the baseline sample, the lower curve (a) represents the NawaStitch™ sample. The point at which initial audible cracking occurred is marked by an arrow: letter “A” refers to the NawaStitch™ sample of curve (a), letter “B” to the baseline sample of curve (b); no noticeable load drop was observed at that point.

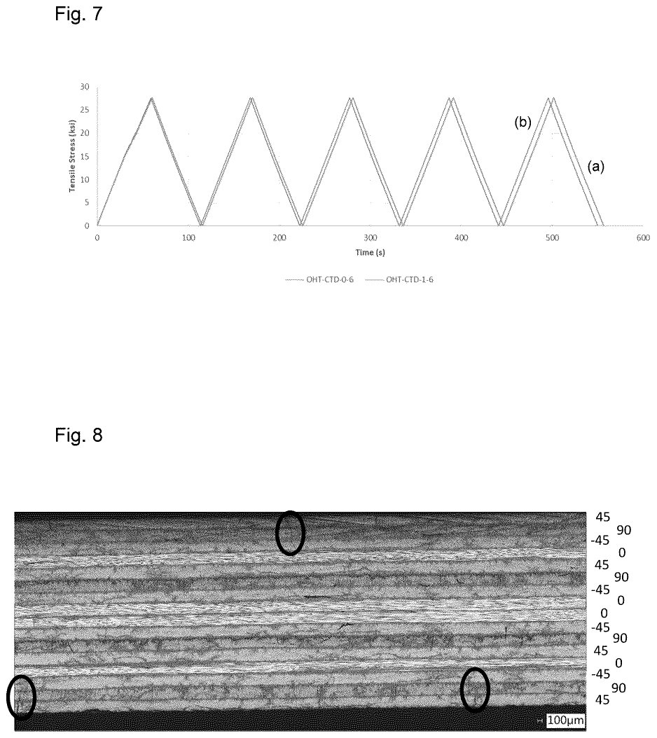

Cyclic testing at cryogenic temperatures is of particular interest for assessing the quality of cryogenic structural materials. FIG. 7 shows the cycling which has been imposed to the samples. A total of five cycles were applied, with a period of about 110 seconds per cycle. Given the small number of cycles, this is of course a highly simplified test. However, a significant difference in the damage induced by such a small number of cycles has been observed for panels having no VACNT-reinforced interfaces and NawaStitch™ panels.

The following tests have been carried out on NawaStitch™ panels used for making cryogenic storage vessels according to the invention, and on baseline panels:
Short Beam Fatigue (80% Ult.) 34-700/NCT1391-1
Short Beam Shear Quasi-isotropic—ASTM D23444—IM77/TC350-1
Interlaminar Tension at 0 °C—ASTM D6415—IM7/TC275-1
Compression after impact—ASTM D7136/D7137—34/700/NTC 301-1
Compression after Half-Impact—ASTM D7137 (3.3.1/mm)—IM7/TC350-1
Short-Beam Shear Quasi-isotropic—ASTM D2344—IM7/8552
Compression after impact—ASTM D1736/1737—IM7/8552
Compression after impact—ASTM D1736/D1714
Combined Loading Compression QI—ASTM D6641—IM7/TC350-1
Short Beam Shear 0 °C—ASTL D2344—IM7/TC350-1

FIG. 8 shows a scanning electron microscopy image of a cross section of a baseline panel after cyclic testing a cryo temperature as shown on FIG. 7. The length of the white bar is 100 μm. We give here for each of the plies (identified by their angle, starting from the top) the number of cracks which have been identified in this image:

45°: 3 cracks; 90°: 12 cracks; −45°: no cracks; 0°: no cracks; 45°: 1 crack; 90°: 11 cracks; 45°: no cracks; 0°: no cracks; 0°: no cracks; −45°: no cracks; 90°: 8 cracks; 45°: no cracks; 0°: no cracks; −45°: no cracks; 90°: 15 cracks; 45°: 3 cracks.

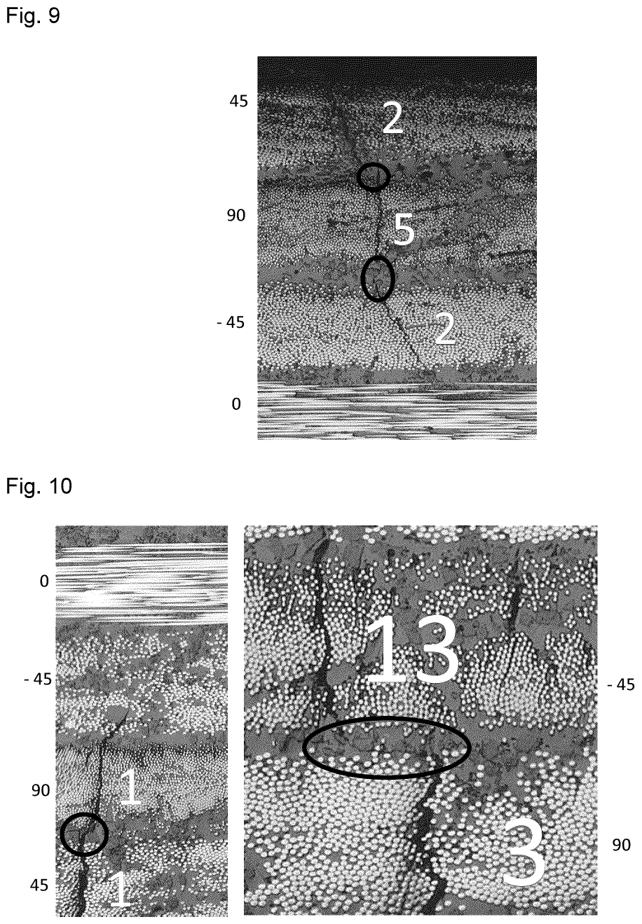

Circled areas of FIG. 8 are zoomed in FIGS. 9 and 10. It can be seen that some of these cracks are propagating across the boundaries of two adjacent plies. As an example, the crack n° 2 on FIG. 10 (left hand picture) extends from the −45° ply into the adjacent 90° ply and into the 45° ply adjacent to the previous one. The crack n° 1 in FIG. 10 extends from the 45° ply into the adjacent 90° ply and into the −45° ply adjacent to the previous one, where its propagation stops. As can be seen from the right-hand picture of FIG. 1°, crack n° 3 in the 90° ply propagates across the resin layer horizontal to the ply and propagates then into the −45° ply.

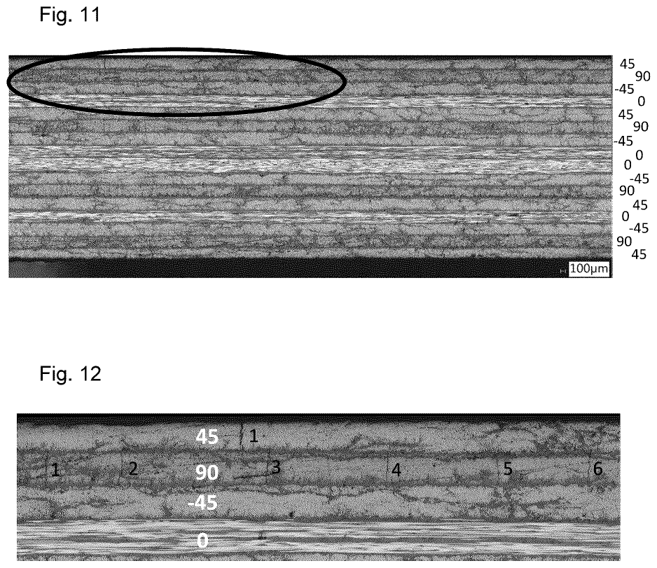

As can be seen from FIG. 11, the NawaStitch™ panels showed no cracks linking between plies. A small number of single cracks, occurring only in a single ply, are visible. It appears that in these laminates, the VACNT-reinforced interface stops cracks from bridging across the interface, leading to fewer overall cracks, and in particular to shorter cracks: the length of cracks hardly exceeds the thickness of an individual ply. In particular, no crack linking was observed between two adjacent layers, as can be seen from FIG. 12, which is a zoom of the highlighted area of FIG. 11. Microcracks were observed within layers, but the crack propagation is stopped at the VACNT-reinforced interface between two adjacent plies.

We give here for each of the plies (identified by their angle, starting from the top) the number of cracks which have been identified in this image:

45°: 2 cracks; 90°: 10 cracks; −45°: no cracks; 0°: no cracks; 45°: 0 crack; 90°: 11 cracks; −45°: no cracks; 0°: no cracks; 0°: no cracks; −45°: no cracks; 90°: 10 cracks; 45°: no cracks; 0°: no cracks; −45°: no cracks; 90°: 5 cracks; 45°: 2 cracks.

Table 2 shows the microcrack count of FIG. 11. It can be seen that microcracking was reduced by about 20% in 90° plies and by about 50% in 45 ° plies of the [45/90/−45/0]_{2S} NawaStitch™ VACNT laminate in comparison to the baseline laminate having the same structure but no VACNT-reinforced interfaces.

TABLE 2

| | | Number of full cracks | | Cracks per inch | |
|---|---|---|---|---|---|
| | | Base- | | Base- | |
| | | line | NawaStitch ™ | line | NawaStitch ™ |
| 90° | plies | 46 | 36 | 92 | 72 |
| ±45° | plies | 10 | 5 | 20 | 10 |

As can be seen on FIG. 12, which is a zoom of a representative area of the image of FIG. 11, these cracks are limited to one ply and do not propagate into neighbouring plies. The inventors believe that this is due to the VACNT layer forming the link between two adjacent plies. In this sense the crack count shown on Table 2 does not properly represent the reality: in the baseline sample the cracks are slightly more numerous (which is reflected on table 2), but more importantly, they are longer and their propagation is not stopped by the VACNT layer between two plies (this effect does not show up in table 2).

While this difference in cracking behaviour between NawaStitch™ panels and baseline panels does not lead to a significant difference in macroscopic mechanical properties, it should be noted that these findings are based on samples which has been submitted to only five cycles of loading and unloading, as shown on FIG. 7. Microcracks, even before impacting recognizably the static and dynamic mechanical properties of composite panels, do increase their hydrogen permeability. This applies in particular to microcracks that occur as audible events under strain.

When the number of cycles is increased, improved macroscopic mechanical properties are observed for NawaStitch™ panels compared to baseline panels; these improved macroscopic properties can then be used for dimensioning cryogenic pressure vessels according to the invention.

While the basic concept of the invention has been tested first on planar NawaStich™ panels, the inventors have recognized that pre-preg plies with VACNT interlayers can be superposed to form nonplanar shapes.

In a first approach, a flexible stack of fiber plies having VANCT interlayers is placed into a shaped mould and infused by a liquid resin (preferably thermoplastic) which is then drawn across the stack under the effect of compression of the stack by a vacuum bag.

In a second approach, a fiber placement process (FPP process) is used. The fiber ply is a flat pre-reg fiber ribbon onto which a VACNT array has been transferred. This ribbon is applied onto the mould surface by using a compaction roller. The mold surface can be the outer surface of a reservoir, such as a pressure bottle.

In a third approach, a filament winding process is used: the fiber ply is a pre-preg filament or a flat pre-preg fiber ribbon, onto which a VACNT array has been transferred. Said filament or ribbon is wound around a rotating mandrel, which can be formed by a mould or a reservoir, such as a pressure bottle.

In each of these three approaches, the orientation of subsequently applied layers can be changed.

In this way, the invention can be used for making cryogenic reservoirs and vessels according to different architectures and geometries. In a first embodiment, the cryogenic reservoir comprises a metal liner and a hoop lap made from resin-impregnated fiber plies having VACNT interlayers. In a second embodiment, the cryogenic reservoir comprises a metal liner and a full lap made from NawaStitch™ panels. In a third embodiment, the cryogenic reservoir comprises a non-metallic liner and a full lap made from NawaStitch™ panels. Said metal liner can be made from carbon steel.

The inventive product has numerous advantages.

The use of NawaStitch™ panels for making cryogenic tanks can reduce the thickness of the tank for a given nominal pressure, or allows, for a given volume, higher gravimetric and volumetric density of stored gas. Due to the intrinsically higher thermal conductivity of such panels, these tanks can be refuelled faster. The higher thermal conductivity of the panel also facilitates the temperature control during the manufacturing process. As the hoop lap or full lap is no longer made by winding glass fiber or carbon fibers around a liner, the manufacturing process is much simpler.

1. Cryogenic vessel for storage of compressed or liquefied gases such as hydrogen, oxygen, nitrogen or air, comprising a composite part built up from alternating superposed composite layers of a laminate composite comprising fibers embedded in a polymer matrix, wherein an array of vertically aligned nanotubes or nanofibers is arranged between two superposed laminate layers.

2. Vessel according to claim 1, wherein said composite layers comprise parallel fibers embedded in a polymer matrix.

3. Vessel according to claim 1, wherein said vertically aligned nanotubes or nanofibers are carbon nanotubes or nanofibers, deposited onto said composite layers.

4. Vessel according to any of claim 1, wherein in two superposed layers of laminate composite, said fibers do not have the same orientation with respect to the plane of said layers.

5. Vessel according to claim 4, wherein said in each two superposed layers of laminate composite, said fibers do not have the same orientation with respect to the plane of the layers.

6. Vessel according to any of claim 1, wherein the outer surface or an outer layer of the vessel comprises a composite layer comprising a horizontal alignment of nanotubes or nanofibres with respect to said superposed layers.

7. Cryogenic vessel according to any of claim 1, wherein the number of said alternating superposed layers is at least 3, and preferably at least 5.

8. Cryogenic vessel according to any of claim 1, where said array of vertically aligned nanotubes or nanofibers is partially embedded in the polymer matrix of each of the two adjacent superposed layers.

9. Cryogenic vessel according to any of claim 1, wherein said an array of vertically aligned nanotubes or nanofibers has an average tube length comprised between about 10 μm and about 150 μm, preferably between about 10 μm and about 100 μm, and still more preferably between about 10 μm and about 50 μm.

10. Cryogenic vessel according to any of claim 1, wherein said gaseous or liquid hydrogen, oxygen, nitrogen or air is in direct contact with said composite part.

11. Cryogenic vessel according to any of claim 1, wherein said composite part is one or more of a tronc, a connector, a tubing, or a dome.

12. Cryogenic vessel according to any of claim 1, wherein said vessel is formed from one single composite part.

13. Cryogenic vessel according to any of claim 1, wherein said fibers are selected from carbon fibers and glass fibers.

14. Method for making a cryogenic vessel according to any of claim 1, wherein said composite part is formed by successive superposition of composite layers, each said composite layers comprising fibers embedded in a polymer matrix, wherein an array of vertically aligned nanotubes or nanofibers is arranged between two superposed laminate layers.

15. Method according to claim 14, wherein horizontally aligned carbon nanotubes are fixed on the outer surface of a stack of composite layers, each said composite layers comprising fibers embedded in a polymer matrix, wherein an array of vertically aligned nanotubes or nanofibers is arranged between two superposed laminate layers.
